(19) United States
(12) Patent Application Publication
(10) Pub. No.: US 2004/0250643 A1
(43) Pub. Date: Dec. 16, 2004

(54) Restrictor lock

(76) Inventor: Gary R. Jones, Virginia Beach, VA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/858,788

(22) Filed: Jun. 2, 2004

Related U.S. Application Data
(60) Provisional application No. 60/478,374, filed on Jun. 12, 2003.

(51) Int. Cl. F16K 17/00

(52) U.S. Cl. 74/473.21

(57) ABSTRACT

A restrictor lock is disclosed for locking in the maximum velocity of a traveling unit. The restrictor lock prevents the movement of a throttle past a certain point. The restrictor lock can be adaptable and interchangeable with various machine types and brands.

### RELATED US APPLICATION DATA

This application claims priority from U.S. Provisional Application No. 60/478,374 filed 12 Jun. 2003.

### BACKGROUND OF THE INVENTION

1. Field of the Invention

The present invention relates generally to a speed limiting system, and more specifically to a restrictor lock that regulates a maximum speed of a riding apparatus.

2. Description of Related Art

Conventional riding lawn mowers and all terrain vehicles (ATVs) are a main cause of thousands of injuries every year, which injuries can include amputation or death. Only a small percentage of such injuries is caused by the mechanical failure of the riding lawn mower. Most injuries are the result of human error, including loss of control of the mower from excessive speed, operating the machine carelessly in reverse, or allowing children to operate the machine without adult supervision.

Hydrostatic drive systems were developed to make accelerating a lawn tractor quick and easy, without the need for a lever and combination brake/clutch to change speed. Pushing a single lever forward increases speed, and pulling it back slows or stops the tractor. However, this type of system also allows inexperienced users to easily accelerate the machines to dangerous speeds, thus further contributing to accidents and injuries.

Speed governors have been developed in an effort to control the maximum speed at which a machine can operate. Some governors limit the fuel supply to an engine depending on external factors such as changes in charging and exhaust pressure or fuel economy. However, these devices do not address the need for manual control of a machine's velocity or gear-shifting ability in response to individualized factors such as terrain or experience level of the user. Additionally, devices that respond to external factors do not serve as a training apparatus to teach a user proper riding velocities to employ under certain conditions. Further, these known devices can be expensive and difficult to use.

Other conventional speed governors limit speed by turning off an engine when a maximum speed is reached. However, this can be quite inconvenient, time consuming, and even dangerous to the user of the vehicle if the vehicle is left disabled.

Some speed governors involve hand-actuated stopping elements for blocking the depression of an accelerator pedal. These devices require a great deal of energy to operate. A user must first set the desired speed by hand, and then the user must continually depress a pedal against a block in order to maintain speed. Additionally, integral in these governors are mechanisms that allow a user to override the speed limit. This could prove harmful to an unsupervised or inexperienced user who may, either advertently or inadvertently, override the speed limit. The user is also unable to readily see the mechanism that actually blocks the pedal, so this device has little training value to the user who may otherwise be alerted when the blocking device is engaged that a certain speed had been reached. Further, these devices cannot be permanently locked into position, and involve costly alterations that must be made in order to integrate them into a machine. Once installed, these conventional speed governors are not readily interchangeable with other machines.

It would be beneficial to provide a speed limiting system, in a single apparatus, that overcomes the disadvantages of known devices, including: (a) the need for individualized control over a machine's speed, (b) the need to teach inexperienced users the proper velocities to employ under changing circumstances when operating a machine, (c) safety concerns associated with being able to override a set maximum speed, (d) expensive integration or replacement, (e) user fatigue, (f) complicated use, and (g) lack of interchangeability and adaptability. What is needed, therefore, is a restrictor lock for locking in a maximum speed for a machine for the safety and education of the user that allows individualized control of speed, is cost effective, is easy and simple to use, and is interchangeable and adaptable.

Therefore, it can be seen that a need yet exists for a superior speed limiting system. It is to such a system that the present invention is primarily directed.

### SUMMARY OF INVENTION

The present invention is a restrictor lock that can lock in a maximum speed of a traveling unit, which enables individualized control of speed, is cost effective, easy and simple to use, interchangeable and adaptable. In a preferred embodiment, the restrictor lock is adapted to compliment most hydrostatic drive systems and manual transmissions, thereby blocking acceleration by shifting the position of a throttle or gear control lever. While the restrictor lock can work with the throttle, the preferred placement is with the gear or speed control lever.

The lock can move along a fitted plate constructed into the unit, and can be secured into place by clamping mechanisms that are actuated by the turning of a key. Alternatively, a plate can be separately constructed and retrofitted onto the unit, into which the locking system can be fitted about the throttle, and tightened. The plate can display various speed or other indicia depending on factors like experience level, terrain, and weather conditions. These indicia contribute to the education of the user so that they might associate a certain level of speed with different terrains and weather conditions.

Therefore it is an object of the present invention to provide a restrictor lock that is easier and safer to use than conventional speed control systems.

It is a further object of the present invention to provide a restrictor lock that serves as a safety feature. The present device can be locked by an adult, providing peace of mind that a child cannot circumvent the safety feature.

It is another object of the present invention to provide a restrictor lock that inhibits a riding unit from operating at high engine speeds.

Yet a further object of the present invention is to provide a restrictor lock that is adaptable to, and interchangeable with, several riding mowers and ATVs.

Another object of the present invention is to provide a restrictor lock that is cost-effective to manufacture.

These and other objects, features and advantages of the present invention will become more apparent upon reading the following specification in conjunction with the accompanying drawing figures.

### BRIEF DESCRIPTION OF THE DRAWINGS

FIG. 1 is an elevation view of a preferred embodiment of a restrictor lock of the present invention.

FIG. 2 is an elevation view showing another embodiment of a restrictor lock.

FIG. 3 is a detailed side view of the attachment system and locking system according to a preferred embodiment of the present invention.

FIG. 4 is a detailed sectional view of a grooved surface of a plate portion.

FIG. 5 is a detailed sectional view of an embodiment of a blocking system and an attachment system.

FIG. 6 is a detailed sectional view of a contoured surface of a plate portion.

FIG. 7 is an elevation view of an embodiment of a unitary restrictor lock construction.

FIG. 8 is an elevation view of another embodiment of a unitary restrictor lock construction.

### DETAILED DESCRIPTION OF A PREFERRED EMBODIMENT

The present invention is a novel restrictor lock device capable of locking a maximum velocity of a traveling unit. The present speed restrictor lock is easy to use, inexpensive, interchangeable, adaptable, and improves the safety and education level of a user of the traveling unit, for example, a riding lawn mower. Referring now to the figures, in which like numerals refer to like elements throughout the several views, exemplary embodiments of the present invention are described.

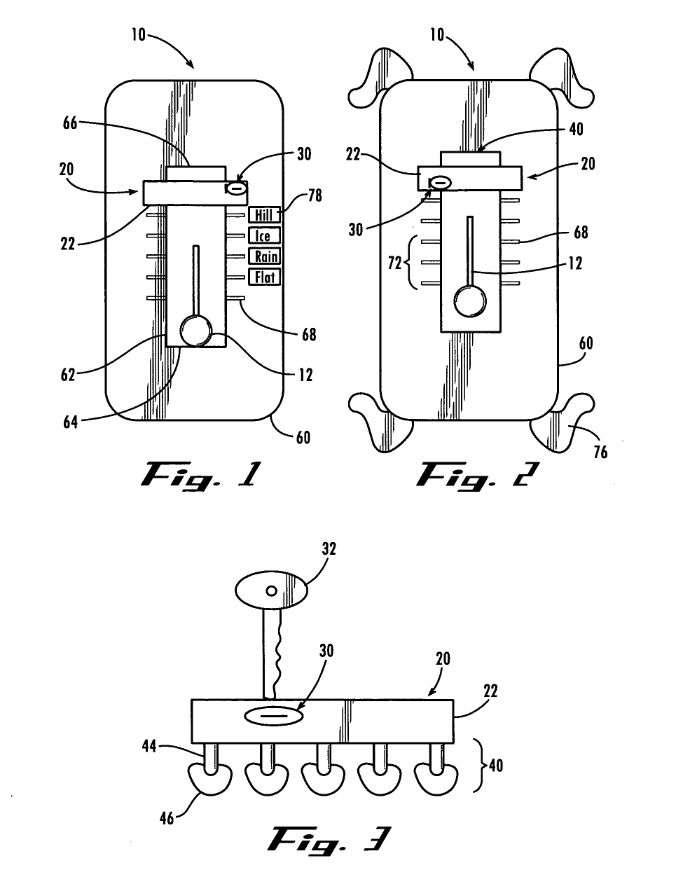

FIG. 1 of the drawings shows a preferred embodiment of a restrictor lock 10 for preferably a motorized vehicle, for example, a riding lawn mower or ATV, comprising a blocking system 20 to block the movement of an acceleration device (here, throttle 12), a locking system 30 to fix the blocking system 20 into a releasably secure position when engaged, and an attachment system 40, as shown in FIG. 2, in communication with the blocking system 20 (FIGS. 2, 3) to releasably attach the blocking system 20 to either the mower or a plate portion 60 adapted to fit the mower.

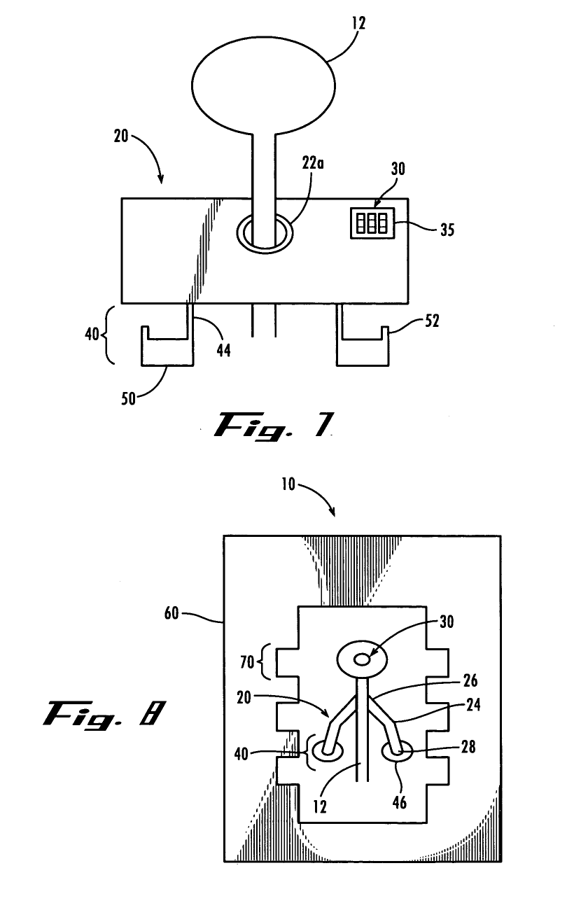

The blocking system 20 blocks the forward advancement of the movement of a throttle 12 through a throttle passage 62 of the plate portion 60 when it is attached to a mower. Blocking the advancement of a throttle 12 with the blocking system 20 serves to impede speed acceleration of the mower past a predetermined limit. The blocking system 20 can comprise a blocking bar 22, as shown in FIG. 2, or an adjustable collar 22a, as shown in FIG. 7. The adjustable collar 22a can attach the blocking bar 22 to the throttle 12 itself to further immobilize the throttle 12. The blocking system 20 can mesh with open slots 68 in the plate portion 60 and can be secured in that position by engaging the locking system 30 which activates the attachment system 40. The blocking system 20 can also be placed in such a position as to prevent the riding lawn mower from operating in reverse or other gears on the throttle passage 62.

Where the restrictor lock 10 and the throttle 12 are a unitary construction, as in FIG. 8, the blocking system 20 can alternatively comprise at least one arm 24 having a first end 26 and second end 28, where the first end 26 is attached to the throttle 12, and the second end 28 is in communication with the attachment system 40. When the arm 24 is positioned into, for instance, an open slot 68 and secured by the attachment system 40, the throttle 12 is releasably secured. The arm 24 can be fashioned to contract or expand to fit into the open slot 68 upon engagement or disengagement of the locking system 30 so that the open slot 68 and arm 24 cooperate to prevent movement of the throttle 12.

The throttle 12 can operate a hydrostatic drive system or a manual transmission. It will be understood for the purposes of FIG. 1 that generally the speed of the engine of the riding lawn mower increases as the throttle 12 advances from the lower end 64 of the throttle passage 62, to the upper end 66. Likewise, in manual transmission vehicles, the capability of increasing speed increases as the throttle 12 is advanced into higher gears. It will be understood that the throttle passage 62 and plate portion 60 can be integral with the design of the traveling device. Blocking the movement of the throttle 12 with the blocking system 20 likewise impedes speed acceleration in a manual transmission vehicle past a predetermined limit.

The present restrictor lock 10 further comprises a locking system 30 that activates the attachment system 40 to releasably secure the blocking system 20 (or the throttle 12) to either the plate portion 60 or to the mower itself. The locking system 30 selectively engages and disengages the attachment system 40, for example, when a key 32 is turned, as demonstrated in FIG. 3, or when a preset combination on a dial 34 is reached, as demonstrated in FIG. 7. For example, dial 34 can include a numbered combination.

Attachment system 40 in communication with the blocking system 20, shown in detail in FIGS. 3, 5, and 7. The attachment system 40 is activated when the locking system 30 is selectively engaged or disengaged, for example, by a key 32 or a number dial 34. The attachment system 40 releasably secures the blocking system 20 to either the plate portion 60 or to the mower itself, and can be fashioned to move in conjunction with the plate portion 60, for example, like a c-clamp.

One preferred embodiment of the attachment system 40, illustrated in FIG. 3, comprises a plurality of protrusions 44 attached at one end to the blocking bar 22, and having a disk 46 attached to the other end. The protrusions 44 and disk 46 are designed to cooperate with the plate portion 60. Protrusions 44 can move to the side or draw near to the blocking bar 22 when actuated by locking system 30, thus releasably fixing the blocking system 20 in a location. The locking system 30 can also disengage the attachment system 40 and release the blocking system 20 from its releasably fixed position.

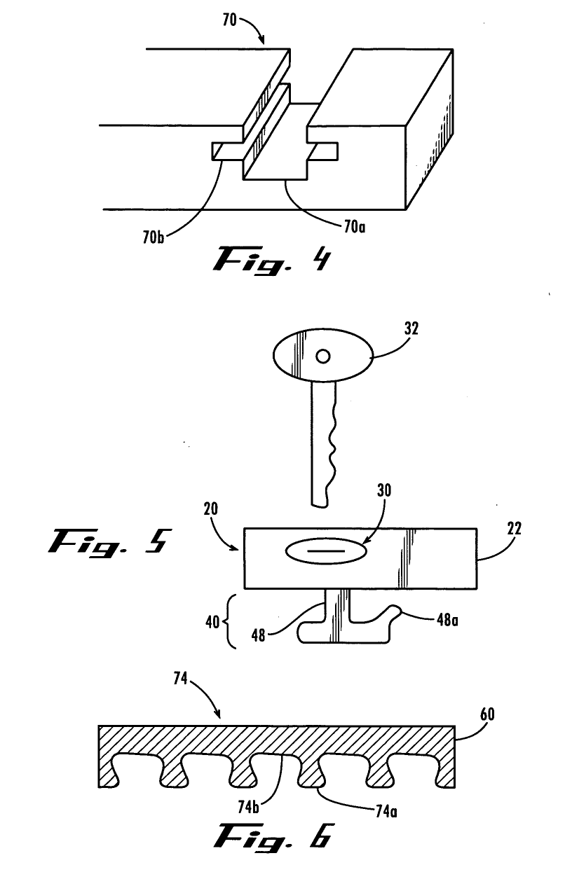

As shown in FIG. 4, another embodiment of the attachment system 40 comprises a curved foot element 48 attached to the blocking bar 22 and secured by a complimentary grooved surface 70 in the plate portion 60. The curved foot element 48 can similarly be drawn toward the blocking bar 22 when the locking system 30 is actuated, thus releasably fixing the blocking system 20 to either the plate portion 60 or the mower itself.

The attachment system 40 can be in communication with the arm 24 when the construction of the restrictor lock 10 is unitary as shown in FIG. 8. A disk 46 is connected to the arm 24 of the blocking system at the second end 28 of the arm 24, and is received by a grooved surface 70 or slotted surface 72 of the plate portion 60. The disk 46 is selectively engaged or disengaged by the locking system 30 simultaneously with the engagement of the arm 24. When the locking system 30 is engaged, the arm 24 and disk 46 are drawn either upward or inward toward the throttle 12, thus meshing the disk 46 and arm 24 with the grooved surface 70 or slotted surface 72 of the plate portion 60. It will be understood that the plate portion 60 and the grooved surface 70, slotted surface 72, or a contoured surface 74 can be integral with the design of the mower. Meshing the disk 46 and the arm 24 with the grooved surface 70 or slotted surface 72 of the plate portion 60 releasably secures the throttle 12 in a predetermined position and serves to inhibit speed acceleration of a mower. Disengaging the locking system 30 similarly releases the throttle 12 from the releasably secure position.

The plate portion 60 is shown as an element separable from the traveling device, used, for example, as a retrofit to a mower. The blocking system 20 can be secured along the plate portion 60 in the fashion of a c-clamp. The plate portion 60 is connected to the mower, either permanently or releasably with clamps 76, as shown in FIG. 2. The plate portion 60 can either have open slots 68 comprising the slotted surface 72 for receiving the attachment system 40, a grooved surface 70, or a contoured surface 74, as shown in detail in FIGS. 1, 4, and 6. These surfaces allow the protrusions 44, a foot 50 (FIG. 7), or a complimentary-shaped attachment connected to the throttle 12 or the blocking system 20 to mesh with the plate portion 60 when the locking system 30 engages or disengages the attachment system 40. This enables the blocking system 20 to be releasably secured in a predetermined position to inhibit speed acceleration.

An exemplary embodiment of plate portion 60 can include indicia 78 on the plate portion 60, as shown in FIG. 1, or directly on the traveling unit to serve as a gauge for the ideal placement of the blocking system 20. These indicia 78 contribute to the education of the user so that they might associate a certain level of speed with different terrains and weather conditions.

FIG. 2 shows a preferred embodiment of the restrictor lock 10 comprising a blocking system 20 incorporating a blocking bar 22, a locking system 30, and an attachment system 40 that is activated by the locking system 30. The attachment system 40 can either attach to the plate portion 60, the throttle 12, or directly to the traveling unit. The plate portion 60 can be detachable or interchangeable, and can be fitted onto a traveling unit using clamps 76. Likewise, the blocking system 20 and attachment system 40 can be adaptable or interchangeable either along or in conjunction with a retrofitted plate portion 60. Thus, a user having a traveling unit that is not specifically manufactured to accommodate such a device can inexpensively purchase universal attachment pieces to add a safety feature to the traveling unit.

FIG. 3 shows a blocking system 20 in greater detail with a locking system 30, which can be selectively activated to engage or disengage the attachment system 40. The locking system 30 can operate with a device such as a key 32 as shown, or through electronic or combination-type lock controls. This prevents an unauthorized or inexperienced user from exceeding the set speed, operating in reverse or a prohibited gear, or even turning on the power of the traveling unit. The locking system 30 need not be located on the blocking system 20, but, for example, can be located including on the throttle 12, the plate portion 60, as displayed in of FIGS. 1 and 2, or the traveling unit. Upon engagement of the attachment system 40 by the locking system 30, the disk 46 is drawn nearer to the blocking system 20 by moving along the protrusions 44. One disk 46 or a plurality of individual disks 46 can be used. In the alternative, the blocking system 20 can be drawn nearer to stationary disk 46 by moving along the protrusions 44. The protrusions 44 are constructed and spaced apart so as to fit into grooves, open slots 68, or contours in the plate portion 60 of FIGS. 1 and 2 as described in more detail below.

FIG. 4 details a sectional embodiment of a plate portion 60 illustrating a grooved surface 70 having a channel 70a and horizontal slit 70b. The horizontal slit 70b is constructed to accommodate the disk 46 shown in FIG. 3.

FIG. 5 details another embodiment of the blocking system 20 and attachment system 40. The blocking system 20 is connected to the plate portion 60 shown in FIGS. 1 and 2 by the attachment system 40. The attachment system 40 comprises the curved foot element 48 that can have an extension 48a. The curved foot element 48 can be moved closer to the blocking system 20 when the locking system 30 engages or disengages it, preferably through a key 32 or another suitable means as described herein. The blocking system 20 can also be moved closer to the curved foot element 48 when the locking system 30 engages or disengages it. Additionally, the extension 48a can be constructed of a flexible material with a movable inner support such that engagement or disengagement of the locking system 30 will cause the extension 48a to flex, thus fixing the attachment system 40 more securely to the plate portion 60, the throttle 12, as shown in FIGS. 1 and 2, or the traveling unit.

FIG. 6 shows an embodiment of a plate portion 60, wherein a contoured surface 74 has extended areas 74a and recessed areas 74b. The contoured surface 74 is constructed to securely hold the curved foot element 48 of FIG. 5, or an element with a complimentary surface.

FIG. 7 of the drawings details yet another embodiment of the blocking system 20. The blocking system 20 is either constructed unitarily with the throttle 12, or can be connected to the throttle 12 by an adjustable collar 22a. The collar 22a is tightened or loosened about the throttle 12 when engaged by the locking system 30, or can be tightened or loosened independently of the locking system 30 using screws, clamps, or other suitable joining devices. The attachment system 40 is selectively engaged or disengaged by the locking system 30. In a preferred embodiment, a locking dial 34 is used to engage and disengage the locking system 30. Foot 50 is attached to the protrusion 44, and toe 52 is attached to foot 50, such that when the locking system 30 engages or disengages the blocking system 20, the foot 50 and toe 52 are drawn toward or away from the blocking system 20, and interlock in the grooved surface 70, contoured surface 74, or slotted surface 72 on the plate portion 60 as described herein.

FIG. 8 shows another embodiment of the restrictor lock 10. The plate portion 60 can be constructed substantially as shown in FIGS. 1, 4, or 6, or the device can be constructed to work without a plate portion 60. The locking system 30 is integrated into the throttle 12. The blocking system 20 comprises arm 24, which is connected at the first end 26 to the throttle 12 and at the second end 28 to the disk 46. The arm 24 can be angled or bent so as to allow the disk 46 to fit into a grooved surface 70 or another suitable complimentary surface, such that when the locking system 30 is engaged or disengaged, the disk 46 will either move outward and upward to mesh with the grooved surface 70 and secure the throttle 12 into a stationary position, or will be released from the grooved surface 70, allowing the throttle 12 to move freely.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A speed limiting system comprising:
a positionable blocking system; and
a locking system to releasably secure the position of the blocking system, wherein once releasably secured, the blocking system impedes the movement of a movable accelerator beyond a defined position.

2. The speed limiting system of claim 1, further comprising a plate through which the accelerator can move.

3. The speed limiting system of claim 1, wherein the locking system is selectively engaged into releasably securement and disengaged from releasably securement.

4. The speed limiting system of claim 3, wherein the locking system is engaged into releasably securement by a key.

5. The speed limiting system of claim 3, wherein the locking system is engaged into releasably securement by number dials.

6. A speed limiting system for a vehicle having a movable accelerator, comprising:
a positionable blocking system;
a plate through which the accelerator can move;
a locking system to releasably secure the position of the blocking system, wherein once releasably secured, the blocking system impedes the movement of the movable accelerator beyond a defined position, the locking system being selectively engaged into releasably securement and disengaged from releasably securement; and
an attachment system in communication with the blocking system and the plate, attaching the positionable blocking system to the plate.

7. The speed limiting system of claim 6, the plate having slots for receiving the attachment system.

8. The speed limiting system of claim 6, wherein the blocking system comprises a blocking bar having an adjustable collar adaptable to the accelerator, wherein the collar tightens to releasably secure the blocking system to the movable accelerator.

9. The speed limiting system of claim 7, the attachment system comprising:
a plurality of protrusions; and
a disk slidably connected to the protrusions;
the protrusions being attached to the blocking system; and
the disk being drawn in proximity to the blocking system when engaged into releasably securement by the locking system.

10. The speed limiting system of claim 6, the plate having a grooved surface for receiving the attachment system, and the attachment system comprising a curved foot element, the curved foot element being attached to the blocking system, wherein the curved foot element is slidably secured in the grooved surface of the plate when engaged into releasably securement by the locking system.

11. A speed limiting system for a motorized vehicle with a moveable gear control lever, comprising:
a positionable blocking device for the moveable gear control lever that impedes the movement of the gear control lever beyond a defined position;
a lock to releasably secure the position of the blocking device;
an attachment system in communication with the blocking device; and
a plate portion in communication with the blocking device, along which the blocking device is secured.

12. The speed limiting system of claim 11, wherein the locking device is selectively activated to engage and disengage.

13. The speed limiting system 11, wherein the blocking device comprises a blocking bar.

14. The speed limiting system of claim 13, wherein the attachment system comprises:
a plurality of protrusions attached to the blocking bar; and
a disk slidably connected to the protrusions, whereby the disk is drawn near to the blocking bar when selective engaged or disengaged by the lock.

15. The speed limiting system of claim 11, the plate portion having a grooved surface for receiving the attachment system.

16. The speed limiting system of claim 15, wherein the attachment system comprises:
at least one arm having a first and second end, the first end attached to the moveable gear control lever; and
at least one foot connected to the second end of the at least one arm, wherein the at least one foot is received by the grooved surface of the plate portion and is selectively engaged or disengaged by the lock.
